(19) United States
(12) Patent Application Publication
(10) Pub. No.: US 2017/0268842 A1
(43) Pub. Date: Sep. 21, 2017

(54) FIREARM-SAFETY-SENSING CAMERA-LIGHT-LASER SYSTEM AND METHOD

(71) Applicant: Donald Kennair, JR., Belle Chasse, LA (US)

(72) Inventor: Donald Kennair, JR., Belle Chasse, LA (US)

(21) Appl. No.: 15/609,109

(22) Filed: May 31, 2017

Related U.S. Application Data
(63) Continuation-in-part of application No. 15/059,427, filed on Mar. 3, 2016.

(51) Int. Cl. F41A 17/06; F41A 17/20; H04N 5/225; H04N 7/18

(52) U.S. Cl. CPC F41A 17/063; H04N 7/185; H04N 7/188; F41A 17/20; H04N 5/2257

(57) ABSTRACT

A firearm-safety-sensing camera-light-laser system apparatus and method, providing a camera that is automatically activated upon the release of the firearm's safety control, and providing a light and a laser pointer, each of which can be automatically activated upon the release of the safety, ensuring that the camera will record events in the firearm's line of fire, starting with the anticipation of discharge of the weapon, associated with release of the safety, and optionally to log and notify an appropriate authority of the release of the safety.

### CROSS-REFERENCE TO RELATED APPLICATIONS

This application is a continuation-in-part of my co-pending application Ser. No. 15/059,427, filed on Mar. 3, 2016 for a “Radio-Frequency Trigger Signal System Apparatus and Method,” the full disclosure of which is incorporated by reference herein and priority of which is hereby claimed.

### BACKGROUND

This invention provides a firearm-safety-sensing camera-light-laser system apparatus and method, featuring a camera that is automatically activated upon the release of the firearm's safety control, and further providing a light and a laser pointer, each of which can be automatically activated upon the release of the safety, ensuring that the camera will record events in the firearm's line of fire, starting with the anticipation of discharge of the weapon (associated with release of the safety), and optionally to log and notify an appropriate authority of the release of the safety.

On a firearm, a safety or safety catch or control is a mechanism used to prevent accidental discharge of the firearm. There are a number of specific configurations and types of safeties, including various internal, passive, or automatic safeties, and various external, active, or manual safeties. The safety on a firearm must be released before the firearm can fire. Therefore, releasing the safety prior to, and in anticipation of, pulling the trigger is part of the standard training for using a firearm. In a military or law-enforcement use of firearms the anticipation of discharging the weapon or apprehension that firing the weapon might become necessary can be inferred from release of the safety. In a confrontational situation, the period of time between releasing of the safety and re-engagement of the safety is a critical period when a “shoot-no-shoot” decision might have to be made. Such a shoot-no-shoot decision is likely to be closely analyzed after the fact, and that analysis can be informed by photographs or videos taken from the firearm's position during that time.

There is a need for a system to ensure that every discharge, and every near-discharge, of firearms and weapons is captured by photos or video automatically taken whenever a firearm's safety is released.

U.S. Publ. No. 2016/0165192 was published Jun. 9, 2016 by Amirbahman Saatchi et al., disclosing “Methods, systems, and apparatuses for capturing and archiving firearm event telemetry and environmental conditions.” The Saatchi publication discloses in a particularly described embodiment a method executing with a device having at least a processor and a memory therein, and being physically coupled to a weapon. The method includes operating a proximity sensor at the weapon, the proximity sensor to trigger an activation event upon removal of the weapon from a weapon holster; detecting the activation event and triggering event archiving; archiving event data by storing event data to the memory of the device; and uploading the event data to a remote storage separate and distinct from the device. The weapon may be a lethal or a non-lethal weapon. In a related embodiment, there is a device capable for mounting to a weapon, the device including at least a proximity sensor to trigger an event upon change in status of the weapon from a holster or to a holster; an audio capture device; a video capture device; a solid state memory to store captured audio, video, and event telemetry data; and a wireless communications interface from the device to a remote location having storage capability distinct from the device.

U.S. Publ. No. 2016/0021329, published Jan. 21, 2016 by Paul Sakiewicz et al., and assigned to Solid Proof Technologies, LLC, discloses an “Emergency Assistance Method and Device for a Firearm.” The invention generally relates to an attachment, pictured at right, for a firearm that communicates with a remote device or person, such as emergency services. One embodiment of the invention is selectively interconnected to a Picatinny rail, weaver rail, or other mounting means, and includes a button that allows a user to initiate communication with emergency services without removing his or her hands from the firearm. The Sakiewicz publication also discloses a light source that may be disposed on any surface of the housing to illuminate the surrounding area, and a camera that may be disposed on the front surface of the housing. In some embodiments, the camera is activated when a user engages a button or other similar feature, and may record the visual and audio data to a local memory of the emergency assistance device, which may then be relayed to another location, such as a remote server.

U.S. Publ. No. 2015/0113851 was published Apr. 30, 2015 by Maiquel Bensayan et al., disclosing a “Realtime Memorialization Firearm Attachment.” The attachment comprises a firearm accessory that includes a body demountably attached to a firearm, the body containing: a camera; a microphone; a memory chip; a micro-controller operable to record a user's firearm activity into the memory chip as captured by the camera and the microphone; and a trigger-switch mechanism demountably attached to a firearm-handle operable by a user's finger to turn the contents of the body on but not off. The body disposed on a firearm further includes a plurality of electronic components operable to: record audio, video, location, time, and date, at the time of usage of a firearm; and transmit the recorded audio, video, location, time, and date outside of the body through a wire, a portable memory, or wirelessly in realtime.

U.S. Pat. No. 9,188,407, issued Nov. 17, 2015 to Larry E. Moore et al. on a “Gun with Side Mounting Plate,” covers an accessory mountable to the side plate of a gun. The accessory may be sighting device, such as a light source, and is preferably a laser, and a power source connectable to the light source. The side plate is positioned on the gun, which is preferably a revolver, preferably by being screwed to it. The side plate includes an attachment mechanism that is preferably located behind the trigger guard and behind the gun cylinder, wherein the accessory is attachable to the attachment mechanism.

U.S. Publ. No. 2005/0179799 was published by Yuriy Umanskiy et al. on Aug. 18, 2005, and discloses a “Firearm Mounted Video Camera.” The publication discloses a video camera mounted to a magazine of a semi-automatic handgun, along with a weapon system incorporating the magazine-mounted video camera. In at least one embodiment, a small video camera is attached to a bottom plate of the ammunition magazine. The video camera is operatively coupled with a small portable video monitor that is carried or worn by the user. Accordingly, the user can use the firearm mounted camera to survey a scene while protected by a barrier, or the user can use the video sighting system to survey a scene in no or low light situations.

U.S. Pat. No. 8,904,698 was issued to Juan Carlos Casas on Dec. 9, 2014, covering a “Modular Power Supply for Use in a Weapon Mountable Designator/Illuminator Unit.” The Casas patent covers a weapon-mountable designator/illuminator unit having a light source adapted to generate a light beam in a direction away from the unit. The light beam is variable between a collimated light beam and a divergent light beam for, respectively, designating a target and illuminating a target area of the weapon. At least a first modular power supply is adapted for installation in the designator/illuminator unit. The power supply includes a cage adapted to receive a power source, a first end adapted to be received within the designator/illuminator unit, and an end cap adapted to be exposed when the power supply is assembled with the unit. The power supply is adapted to deliver power from its power source to the light source of the designator/illuminator unit. The end cap may contain a light source for generating a light beam in addition to the light beam generated by the designator/illuminator unit.

U.S. Pat. 6,230,431, filed by Hsiung Bear and issued to Limate Corporation on May 15, 2001, covers a “Night Laser Sight.” The night laser sight comprises a maintube assembly including a first receiving space having a first beam outlet, and a second receiving space having a plurality of second beam outlets being integrated with the first receiving space; a front cover having a third beam outlet securing to a front of the first receiving space; a laser module disposed at a rear of the front cover; a light-emitting diode (“LED”) means disposed within the second receiving space; a plurality of batteries disposed at a rear of the laser module for providing an electric current to the laser module and the LED means; a switch means disposed in a rear of the plurality of batteries; and a switching controller disposed in a rear of the second receiving space. When the switch means is turned on, the laser module and the LED means is turned on simultaneously, or the laser module is turned on and the LED means is turned off, thereby emitting a laser beam from the first beam outlet and a pair of laser beams from the second beam outlets, respectively.

U.S. Pat. No. 5,685,105 was issued to James W. Teetzel on Nov. 11, 1997 for an “Apparatus for Attaching a Flashlight to a Firearm.” The flashlight module can fit conventional handguns and rifles without requiring major modification of the weapons, and yet fits within the profile of the weapon framework. The apparatus features a chassis containing a flashlight that can be mounted in various positions, depending on the weapon selected. For a handgun, the chassis mounts on the front face of the muzzle. The weapons factory installed handgrips are replaced by modified handgrips that contain the flashlight electronic controls, waterproof activation switches, and power source. The hand grips are wired to the chassis via a flexible internal circuit tape in the case of the 9 mm, and a waterproof quick-disconnect cable for the M-16. The apparatus is designed to be used with commercially available batteries, providing several hours of operating time.

There is accordingly a need to solve the problems associated with the lack of information regarding circumstances surrounding the discharge, and anticipated discharge, of weapons. Specifically, there is a need in the art for a safety-triggered camera activation, and for a firearm with a built-in camera-light-laser system to assist in providing information about circumstances surrounding the discharge of weapons.

### SUMMARY OF THE INVENTION

This invention provides a firearm-safety-sensing camera-light-laser system apparatus and method that providing a camera, automatically activated upon the release of the firearm's safety control, and a light and a laser pointer, each of which can be automatically activated upon the release of the safety, ensuring that the camera will record events in the firearm's line of fire, starting with the anticipation of discharge of the weapon associated with release of the safety, and optionally to log and notify an appropriate authority of the release of the safety.

This invention helps solve the problems associated with not having more complete information about circumstances surrounding the discharge and anticipated discharge of weapons.

### BRIEF DESCRIPTION OF DRAWINGS

Reference will now be made to the drawings, wherein like parts are designated by like numerals, and wherein:

FIG. 1 is a schematic front perspective view of a built-in embodiment of the firearm-safety-sensing camera-light-laser system incorporated into a pistol;

FIG. 2 is a schematic side view of a built-in embodiment of the firearm-safety-sensing camera-light-laser system incorporated into a pistol;

FIG. 3 is a schematic rear perspective view of a built-in embodiment of the firearm-safety-sensing camera-light-laser system incorporated into a pistol;

FIG. 4 is a front perspective view of a retrofit embodiment of the firearm-safety-sensing camera-light-laser system;

FIG. 5 is a rear perspective view of a retrofit embodiment of the firearm-safety-sensing camera-light-laser system;

FIG. 6 is a perspective view of a retrofit embodiment of the firearm-safety-sensing camera-light-laser system mounted onto a pistol;

FIG. 7 is a perspective view of a retrofit embodiment of the firearm-safety-sensing camera-light-laser system not mounted onto a pistol;

FIG. 8 is a perspective see-through view of a retrofit embodiment of the firearm-safety-sensing camera-light-laser system mounted onto a pistol; and

FIG. 9 is rear perspective schematic view of a retrofit embodiment of the firearm-safety-sensing camera-light-laser system before and after being mounted onto a pistol.

### DETAILED DESCRIPTION OF THE INVENTION

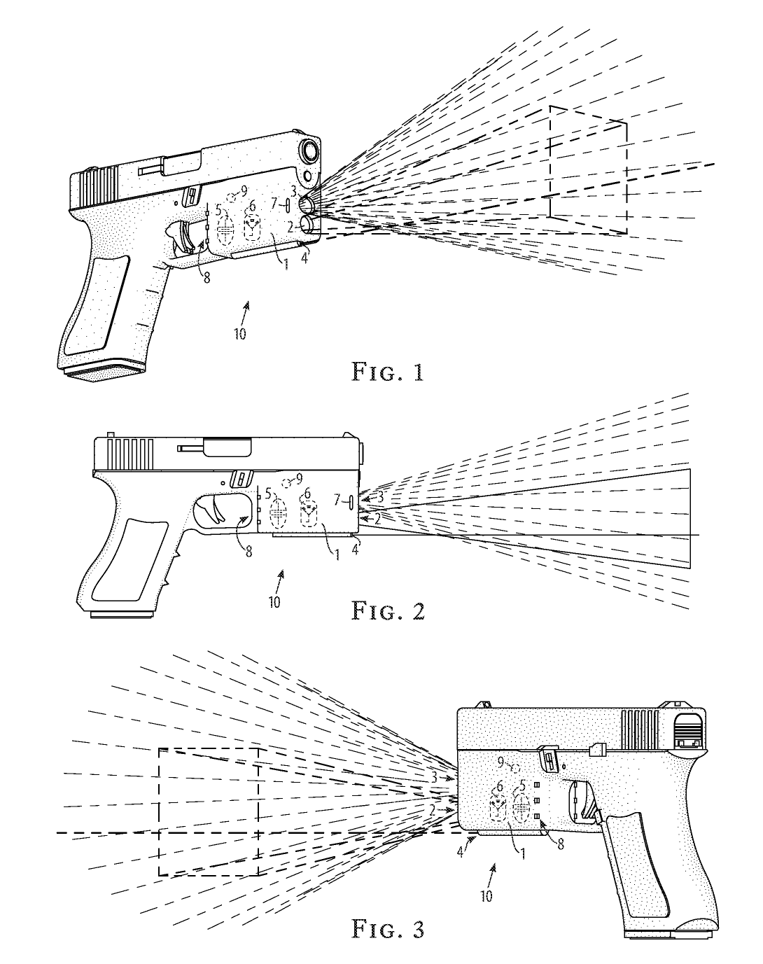

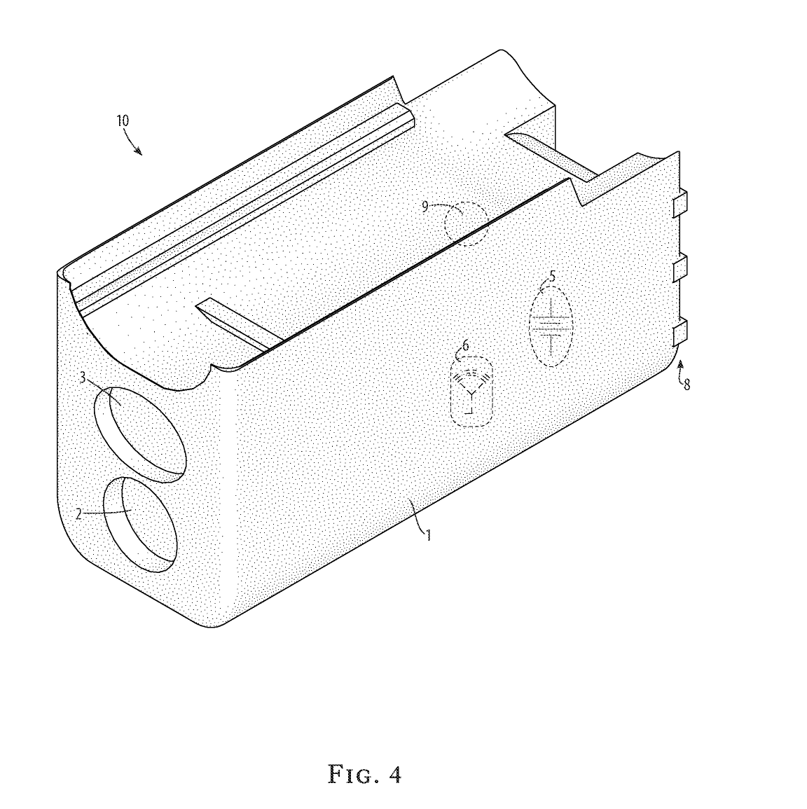

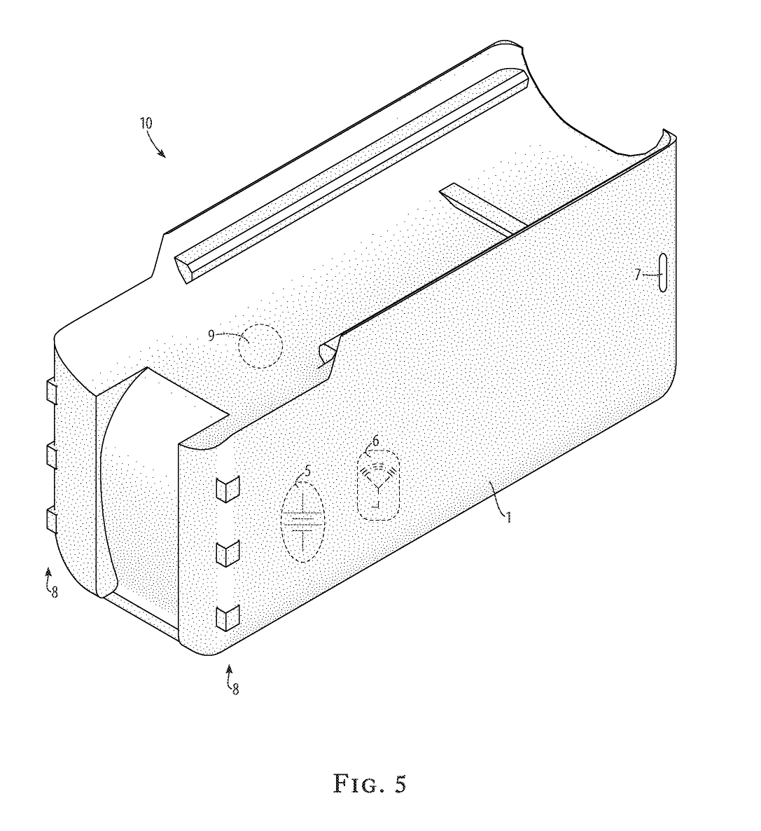

Referring to FIG. 1, FIG. 2, & FIG. 3, and all figures generally, the firearm-safety-sensing camera-light-laser system 10 of the invention is shown schematically with indications of light rays and a laser beam, for the purpose of aiming, emanating from the invention, and with an indication of the field of view of a camera recording videos or photographs of the area in the line of fire. The embodiment illustrated is a built-in embodiment incorporated into a firearm at the time of manufacture. The firearm-safety-sensing camera-light-laser system 10 is illustrated in relation to a semi-automatic pistol, but is intended for use in or on other firearms, such as other handguns, rifles, and shotguns.

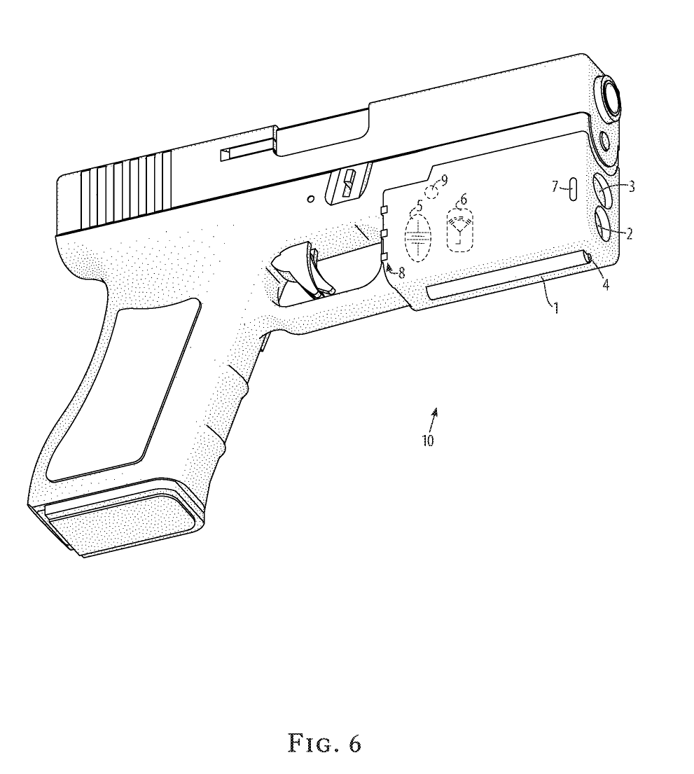

Referring to FIG. 4 & FIG. 5, a retrofit embodiment, in the form of a separate unit to be mounted onto a pistol, is shown.

The elements of the firearm-safety-sensing camera-light-laser system 10 are a unit body 1, either built into the firearm at the time of manufacture or provided as a separate retrofit unit. The unit body 1 is either built into or retrofit-mounted upon the receiver section of the firearm. For reference, the unit body 1 has a front face aligned essentially perpendicular to the firearm's barrel, so that the front face faces the line of fire. A rear face faces the firearm's trigger, and a bottom face faces downward in use. The unit body 1 has two side faces, designated left and right with reference to the firearm in shooting position.

The unit body 1 provides a safety-disengaged sensor 9 to determine when the safety of the firearm is disengaged, readying the weapon for firing. There are a large variety of safety mechanisms among the different firearms, and the safety-disengaged sensor 9 needs to be able to sense the state of the specific type of safety in a specific brand or type of firearm. For the built-in embodiment, incorporated into the firearm at the time of manufacture, the proper configuration of safety-disengaged sensor 9 can be chosen, and direct access to the safety mechanism itself is possible. For the retrofit embodiment, the safety-disengaged sensor 9 needs to be matched to specific types of safety mechanisms by sensing either the safety “catch” itself or by sensing some resulting movement or change in related parts of the firearm. It is possible to have the safety-disengaged sensor 9 sense the presence of, for instance, a finger inside the trigger guard, or the unholstering or raising of the firearm, as a proxy for disengagement of the safety. The appropriate safety-disengaged sensor 9 for a given firearm might be a microphone or vibration sensor to sense a click, sound, or vibration caused by disengagement of the safety. The appropriate safety-disengaged sensor 9 might be an accelerometer or similar device for sensing either movements within the gun or movements of the gun itself, such as unholstering or raising to a firing position.

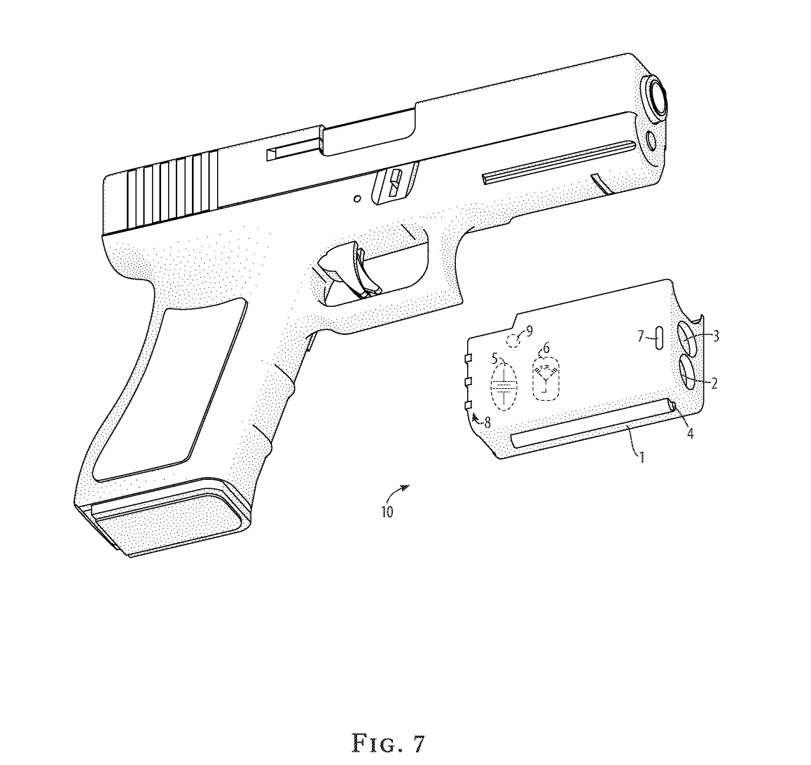

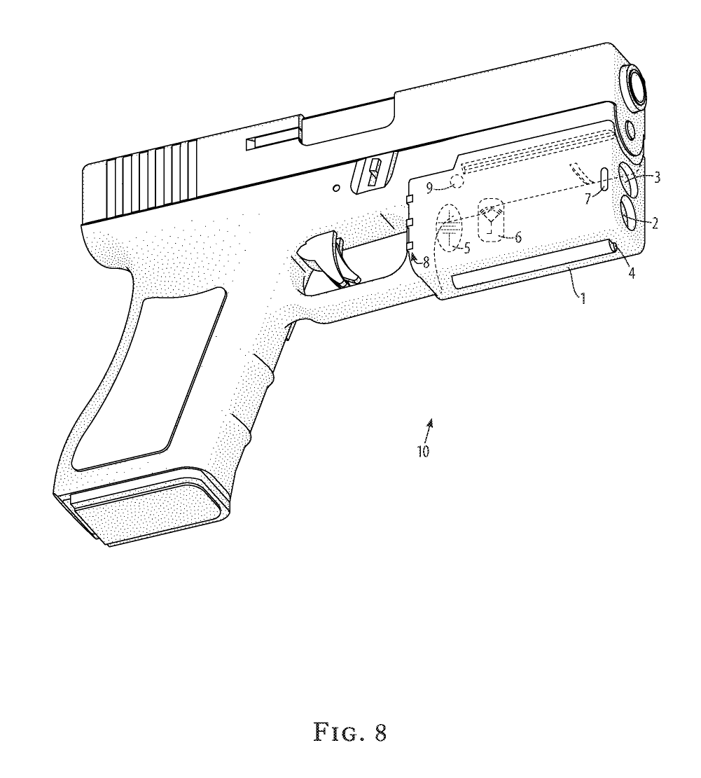

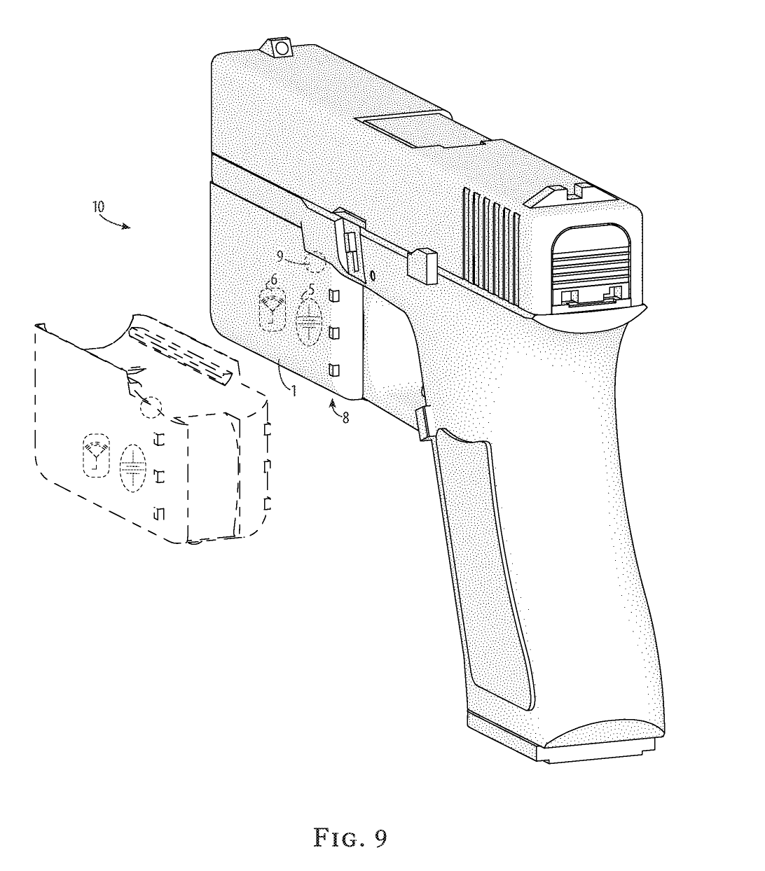

Referring to FIG. 6, FIG. 7, & FIG. 8, the unit body 1 provides a camera 2, a light 3, and a laser pointer 4, each with its lens located on or closely in front of or behind the front face, so that the field of view of the camera 2 and the beam of the light 3 are essentially co-axial with the firearm's barrel, and so that the beam of the laser pointer 4 essentially tracks the path of a bullet, making any necessary adjustments for parallax and distance.

Many standard cameras provide an IR-cut filter to filter out infrared light when taking pictures in sufficient daylight or ambient light. For nighttime use, the IR-cut filter can be removed, and the camera can respond to ambient IR light and to provided IR lighting. Without the IR-cut filter, daylight pictures will have an off-color cast because the IR light is also reaching the sensor, and that off-color cast is aesthetically unpleasant and not an accurate representation of the normal human perception of colors. The purpose of the camera 2 in the firearm-safety-sensing camera-light-laser system 10 is to capture analytical and possibly forensic information, with small concern for aesthetics, and a camera 2 having no IR-cut filter, or a minimal IR-cut filter, will perform better and capture more information in low-ambient-light conditions, and will not suffer a loss of detail, as opposed to color information, in higher-ambient-light conditions. The IR-cut filter, and a mechanism to insert and remove the IR-cut filter in changing lighting conditions, can accordingly be safely omitted from the camera 2 here.

The light 3 can be useful for illuminating a subject for the camera 2, but there are arguable disadvantages of having the light 3 be automatically activated. If the camera 2 is capable of utilizing infrared light, then additional light should not be required. Visible-spectrum light from the light 3 can be useful for helping the human operator see, and the light 3 can be turned on and off as needed. Also, the light 3 can be configured to provide infrared light to better illuminate a subject for the camera 2, and for whatever night-vision equipment might be available. The light 3 can also be configured to provide ultraviolet light which highlights and reveals certain materials and conditions, which might be useful information in the circumstances. The light 3 can be a wide-spectrum light providing ultraviolet, visible, and infrared illumination.

The unit body 1 provides a battery 5 for operation of the camera 2, light 3, and laser pointer 4. The battery can be rechargeable, in which case the specific placement within the unit body 1 is less restricted than for replaceable batteries, which would require placement near an outer surface of the unit body 1 and the provision of an access method, such as a battery cover. The camera 2 also provides memory for storage of videos or photos. Optionally, a microphone can be provided for the capture of sound.

The unit body 1 optionally provides a transmitter or transceiver 6 to send or receive information, either in real time or as a means of later off-loading the stored videos, photos, or other information. An encrypted RF transmission protocol such as BLUETOOTH is appropriate.

The unit body 1 provides a transfer port 7 that can serve two functions: (1) to provide communications between the firearm-safety-sensing camera-light-laser system 10 and external computer or storage systems, and (2) to provide a connection for electrical power for purposes such as re-charging the power source or battery. The transfer port 7 can be in the form of a socket for receiving a plug, or can be an inductive or wireless connection, such as a wireless charger or near-field communications, both presently known and available for portable telephones. Optionally, the transfer port 7 can be placed in a location and orientation which provides for contact with a plug or an inductive-charging surface when a firearm is in a case or in a holster, which allows for charging or data transfer in the field. If a socket-type transfer port 7 is used, placement on the front face of the unit body 1 will allow for connection to a corresponding plug placed at the far end of a holster.

Referring additionally to FIG. 9, a set of manual controls 8 is placed on or near the rear face of the unit body 1, nearest the trigger. Ideally, duplicate manual controls 8 are placed on both the right and left sides in order to accommodate right- and left-handed operation. Placement close to the trigger promotes ease of locating and manipulating the manual controls 8 in the field. Although the firearm-safety-sensing camera-light-laser system 10 can be configured to automatically activate the light 3 or the laser pointer 4 upon release of the safety, such automatic activation might be undesirable in some circumstances, such as a stealthy approach or a non-obvious covered position. The light 3 and the laser pointer 4 can also be activated and deactivated with the manual controls 8, allowing the light 3 and the laser pointer 4 to be easily activated. Also, the camera 2 can be activated even when the safety is engaged by using a manual control 8.

Many other changes and modifications can be made in the system and method of the present invention without departing from the spirit thereof. I therefore pray that my rights to the present invention be limited only by the scope of the appended claims.

I claim:

1. A firearm-safety-sensing camera-light-laser system apparatus for automatically capturing a photographic recording along the line of fire of a firearm, where said firearm features a safety, during periods when the safety is released, the firearm-safety-sensing camera-light-laser system comprising:
(i) a unit body adapted to extend the receiver section of the firearm, said unit body having a front face, rear face, bottom face, and right and left side faces;
(ii) a safety-disengaged sensor adapted to sense the disengagement of the safety of the firearm and to activate other components;
(iii) a camera installed in said unit body close to and essentially co-planar with said front face, adapted to record the scene along the line of fire;
(iv) a light installed in said unit body close to and essentially co-planar with said front face, adapted to cast a beam of light along the line of fire;
(v) a laser pointer installed in said unit body close to and essentially co-planar with said front face, adapted to cast a laser beam along the line of fire;
(vi) a battery installed in said unit body adapted to provide electrical energy to other components;
(vii) a transfer port installed in said unit body adapted to the transfer of recorded data to an external device, and to the transfer of electrical power for charging of said battery; and
(viii) a plurality of manual controls installed on said unit body close to said rear face, adapted to provide manual activation and deactivation of said light and said laser pointer, and to provide manual activation of said camera;
where, in use, upon said safety-disengaged sensor discerning the disengagement of the safety, said camera begins recording the scene along the line of fire; and
where such recordings are subsequently transferred to an external device for subsequent viewing, analyzing, and storing.

2. The firearm-safety-sensing camera-light-laser system apparatus of claim 1, further comprising:
(ix) a transceiver installed in said unit body, adapted to transmit photographic recordings and other data.

3. The firearm-safety-sensing camera-light-laser system apparatus of claim 1, where said unit body is built into the receiver of the firearm at the time of manufacture.

4. The firearm-safety-sensing camera-light-laser system apparatus of claim 1, where said unit body is a separate retrofit unit attached to the receiver of the firearm.

5. The firearm-safety-sensing camera-light-laser system apparatus of claim 1, where said transfer port is a socket adapted to accept a plug.

6. The firearm-safety-sensing camera-light-laser system apparatus of claim 1, where said transfer port further comprises a wireless means of data communication.

7. The firearm-safety-sensing camera-light-laser system apparatus of claim 1, where said transfer port further comprises an inductive wireless means of re-charging said battery.

8. The firearm-safety-sensing camera-light-laser system apparatus of claim 1, where said camera is sensitive to infrared light.

9. The firearm-safety-sensing camera-light-laser system apparatus of claim 1, where said light provides light outside of the visible spectrum.

10. The firearm-safety-sensing camera-light-laser system apparatus of claim 1, where said unit body is further adapted for use on a semi-automatic pistol.

11. A firearm-safety-sensing camera-light-laser system method for automatically capturing a photographic recording along the line of fire of a firearm, where said firearm features a safety, during periods when the safety is released, the firearm-safety-sensing camera-light-laser system method comprising:
(i) providing a firearm-safety-sensing camera-light-laser system, further comprising:
(a) a unit body adapted to extend the receiver section of the firearm, said unit body having a front face, rear face, bottom face, and right and left side faces;
(b) a safety-disengaged sensor adapted to sense the disengagement of the safety of the firearm and to activate other components;
(c) a camera installed in said unit body close to and essentially co-planar with said front face, adapted to record the scene along the line of fire;
(d) a light installed in said unit body close to and essentially co-planar with said front face, adapted to cast a beam of light along the line of fire;
(e) a laser pointer installed in said unit body close to and essentially co-planar with said front face, adapted to cast a laser beam along the line of fire;
(f) a battery installed in said unit body adapted to provide electrical energy to other components;
(g) a transfer port installed in said unit body adapted to the transfer of recorded data to an external device, and to the transfer of electrical power for charging of said battery; and
(h) a plurality of manual controls installed on said unit body close to said rear face, adapted to provide manual activation and deactivation of said light and said laser pointer, and to provide manual activation of said camera;
(ii) using said firearm-safety-sensing camera-light-laser system in such a way that, upon said safety-disengaged sensor discerning the disengagement of the safety, said camera begins recording the scene along the line of fire;
(iii) subsequently transferring the resulting recordings to an external device; and
(iv) subsequently viewing, analyzing, and storing said resulting recordings.

12. The firearm-safety-sensing camera-light-laser system method of claim 11, further comprising (i) a transceiver installed in said unit body, adapted to transmit photographic recordings and other data.

13. The firearm-safety-sensing camera-light-laser system method of claim 11, where said unit body is built into the receiver of the firearm at the time of manufacture.

14. The firearm-safety-sensing camera-light-laser system method of claim 11, where said unit body is a separate retrofit unit attached to the receiver of the firearm.

15. The firearm-safety-sensing camera-light-laser system method of claim 11, where said transfer port is a socket adapted to accept a plug.

16. The firearm-safety-sensing camera-light-laser system method of claim 11, where said transfer port further comprises a wireless means of data communication.

17. The firearm-safety-sensing camera-light-laser system method of claim 11, where said transfer port further comprises an inductive wireless means of re-charging said battery.

18. The firearm-safety-sensing camera-light-laser system method of claim 11, where said camera is sensitive to infrared light.

19. The firearm-safety-sensing camera-light-laser system method of claim 11, where said light provides light outside of the visible spectrum.

20. The firearm-safety-sensing camera-light-laser system method of claim 11, where said unit body is further adapted for use on a semi-automatic pistol.
